(19) United States
(12) Patent Application Publication
(10) Pub. No.: US 2009/0122680 A1
(43) Pub. Date: May 14, 2009

(54) Method for determining a parameter space for finding optimal operating parameters for reading or writing a storage medium

(75) Inventors: Tony P. Van Endert, Taipei (TW); Maarten Kuijper, Taipei (TW)

Correspondence Address: BACON & THOMAS, PLLC, 625 SLATERS LANE, FOURTH FLOOR, ALEXANDRIA, VA, 22314-1176, US

(73) Assignee: PHILIPS & LITE-ON DIGITAL SOLUTIONS CORPORATION, Taipei (TW)

(21) Appl. No.: 11/984,132

(22) Filed: Nov. 14, 2007

(51) Int. Cl. G11B 20/18

(52) U.S. Cl. 369/53.44

(57) ABSTRACT

A method for determining a parameter space for finding optimal operating parameters for reading or writing storage medium is provided. In an embodiment of the invention, the method includes: setting a first parameter range of a first operating parameter and a second parameter range of a second operating parameter; normalizing the first and the second parameter ranges respectively and forming an initial parameter space based on the normalized first and second parameter ranges; and rotating the initial parameter space by a rotation angle and forming an actual parameter space based on the rotated initial parameter space. The actual parameter space is expected to result in more reliable optimal operating parameters.

### BACKGROUND OF THE INVENTION

1. Field of the Invention

The invention relates in general to a method for determining a parameter space for finding optimal operating parameters, and more particularly to a method for determining a parameter space for finding optimal operating parameters for reading or writing a storage medium.

2. Description of the Related Art

Before reading and writing the storage medium, the operating parameters, such like reading parameters and writing parameters, are set first respectively. The operating parameters of a storage medium drive are the way in which it writes or read a storage medium and have big influence on reading and writing performance.

Traditionally, these operating parameters are predetermined by the medium manufacturer and stored in the medium information. However, in practice the method to prescribe the operating parameters by the medium manufacturer is not very reliable. Therefore, the drive manufacturer creates a list in the firmware of the drive, for a number of different media known before the production of the drive. However, as new storage media regularly coming to market, the way to ensure an up-to-date media list for best reading and writing quality is to update their storage medium drives with the latest firmware. Such approach, in fact, is undesirable operation since it is inconvenient for the consumers.

Therefore, a self-learning operating parameter tuning method has been developed to determine optimal operating parameters even though a storage medium is unknown, i.e. not the one listed in a predetermined media list in the firmware of a storage medium drive. The optimal operating parameters can be the optimal write strategy parameters for writing operation or the optimal servo parameters for reading operation.

The self-learning operating parameter tuning method executes a series of tests on an ‘unknown’ storage medium to determine the optimal operating parameters to read or write data. In contrast, a traditional storage medium drive, without such a self-learning approach, would read and write data on any new storage media that are not in the media list of the drive using standard parameters. This could result in lower operation speeds and reducing the playability and writing quality of storage medium drives.

Specifically, in writing operation, for a certain step in self-learning operating parameter tuning technology, a number (e.g. 13) of experiments are done where two write strategy parameters located within respective pre-defined parameter ranges will be changed at the same time. For every experiment, characteristic measure values, such as jitter value, will be measured. From the characteristic measurement values, a fit to a second order model will be made. All these experiments have to be successful; otherwise the model that will be made is not correct and becomes unreliable.

Also in reading operation, a self-learning operation parameter tuning technology is done first to determine the optimal servo parameters, such as the focus offset and the spherical aberration, for optimizing the reading performance. Similar to writing operation, a number of experiments are done where two servo parameters located within respective pre-defined parameter ranges will be changed at the same time. For every experiment, characteristic measurement values, such as HF-jitter value, will be measured. From the characteristic measurement values, HF-jitter values, a fit to a second order model will be made until fining optimal reading parameters.

In general, operating parameters of some storage media, such as DVD±R media, are not sensitive with respect to bad characteristic measurement values if experiments are executed within wide pre-defined parameter ranges. This means that there is no need to recover bad characteristic measurement values. In this way, the pre-defined ranges of operating parameters are valid for this kind of storage media.

However, such characteristics may not apply to all new storage media. For example, Blu-ray (BD-R) storage media have been available in the market to provide higher capacity and performance than conventional storage media. To maximize capacity and performance, the main optical system parameters of the BD-R storage media include a laser diode with a wavelength 405 nm and an objective lens with a NA of 0.85. With respect to operating parameters change, this kind of storage media, such like BD-R, are much more sensitive. Such sensitivity is reflected in failure to obtain a valid characteristic measurement values in an experiment associated with some specific values of parameters, i.e. the measured value in the experiment being invalid. Therefore, the conventional self-learning operating parameter tuning approach may be unreliable.

### SUMMARY OF THE INVENTION

The invention is directed to a method for determining a parameter space for finding optimal operating parameters for reading or writing a storage medium. An actual parameter space is determined to avoid the invalid characteristic measurement values and is expected to result in more reliable optimal operating parameters.

According to a first aspect of the present invention, a method for determining a parameter space for finding optimal operating parameters for reading or writing a storage medium is provided. The method includes the following steps. (a) A first parameter range of a first operating parameter and a second parameter range of a second operating parameter are set. (b) The first and the second parameter ranges are respectively normalized and an initial parameter space is formed based on the normalized first and second parameter ranges. (c) The initial parameter space is rotated by a rotation angle and an actual parameter space is formed based on the rotated initial parameter space.

According to a second aspect of the present invention, a method for determining a set of experiments for finding optimal operating parameters for reading or writing storage medium is provided. The method includes the following steps. (a) A first parameter range of a first operating parameter and a second parameter range of a second operating parameter are set. (b) An initial set of experiments with respect to several pairs of values of the first operating parameter and the second operating parameter is determined. (c) The first and the second parameter ranges are respectively normalized and an initial parameter space is formed based on the normalized first and second parameter ranges. (d) Each of the initial set of experiments is mapped to an experiment point in the initial parameter space. (e) The initial parameter space is rotated by a rotation angle and an actual parameter space is formed based on the rotated initial parameter space. (f) The experiment points in the initial parameter space are mapped to the actual parameter space. (g) An actual set of experiments is determined according to the step (f).

The invention will become apparent from the following detailed description of the preferred but non-limiting embodiments. The following description is made with reference to the accompanying drawings.

### BRIEF DESCRIPTION OF THE DRAWINGS

FIG. 1 is flowchart illustrating a method for determining an actual parameter space for finding optimal operating parameters, according to an embodiment of the invention.

FIG. 2 is a graph of a distribution pattern of points in an initial parameter space, wherein the points represents an initial set of experiments with respect to two parameters.

FIG. 3 illustrates a rotation of an initial parameter space about the central point by a rotation angle for determining an actual parameter space in setting an actual set of experiments, according to an embodiment of the invention.

FIG. 4 is a graph of a distribution pattern of points in an actual parameter space, derived from FIG. 3, wherein the points are regarded as an actual set of experiments with respect to two parameters.

### DETAILED DESCRIPTION OF THE INVENTION

Regarding finding optimal operating parameters, a self-learning operating parameter tuning method is used, and the characteristic measurement values, such as jitter, SER, and so on, will be used to measure the performance for each experiment. The characteristic measurement values for each experiment have to be valid to construct a reliable model. Specifically, a high-frequency phase-locked loop (HF PLL) of a drive must be locked to the signal received from the storage medium, i.e. the incoming signal for measurement of characteristic measurement values, i.e. read action.

For example, a self-learning operating parameter tuning method for writing operation, the operating parameters can be the laser power P in mW and the pulse width T_{MP}_{_{—}}_{P} in ns, and the characteristic measurement values can be the jitter values. As the example, the jitter values fail at a certain experiment, i.e. the HF-PLL is unable to lock on the incoming signal due to poor write performance, as shown in TABLE 1 below.

TABLE 1

| | | Power (mW) | | | | |
|---|---|---|---|---|---|---|
| Average jitter | | 230 | 252 | 275 | 298 | 320 |
| T_{MP}_{_{—}}_{P} | 9.25 | HF PLL | | 17.0% | | 18.8% |
| (ns) | | Out of | | | | |
| | | lock | | | | |
| | 9.8125 | | 12.2% | | 14.2% | |
| | 10.375 | 14.1% | | 11.7% | | 15.7% |
| | 10.9375 | | 11.1% | | 13.7% | |
| | 11.5 | 17.1% | | 13.6% | | 19.0% |

In TABLE 1, the average jitter values in percentage (%) for a number of experiments, e.g. 13 experiments, associated with two operating parameters, power P in mW and pulse width T_{MP}_{_{—}}_{P} in ns, are shown. It is noted that one experiment fails. The chance to have PLL unlock is the highest at a “corner” of TABLE 1 where the two operating parameters for a certain experiment are substantially at ends of their pre-defined parameter ranges.

Because of the failed jitter values in the “corner”, i.e. the operating parameter point (230, 9.25), the outcome of the second order model fit becomes highly unreliable. Such operating parameter point should be avoided in order to determine optimal operating parameters. However, a wide as possible parameter range is still preferred to enable the search

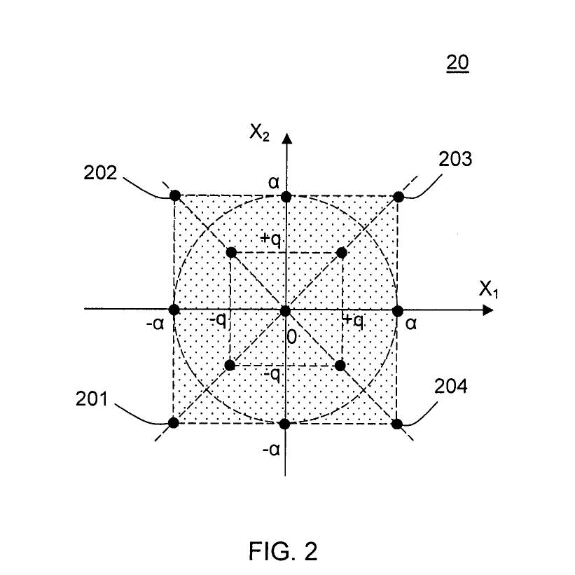

Generally, in the self-learning operating parameter tuning method, pre-determined parameter ranges for each of operating parameters are set first, and then, a set of experiments with respect to a first operating parameter and a second parameter is determined for measuring the characteristic measurement values of each of the set of experiments. Each of the set of experiments is associated with values of the first and second operating parameters, and the values of the first and second operating parameters are within its own parameter ranges. As shown in FIG. 2, the set of experiments forms a parameter space 20 in the parameter ranges with respect to the first and the second operating parameters listed in TABLE 1, for example the operating parameter point (230, 9.25) is mapped as the point 201.

As mentioned above, the parameter space 20 of the first and second operating parameters as shown in FIG. 2 have higher chance to get the failed characteristic measurement values in the “corner”, such as the points 201 to 204 in FIG. 2. Therefore, the present invention provides a method for determining a parameter space of the first and second operating parameters, which have higher reliability than the parameter space 20 shown in FIG. 2.

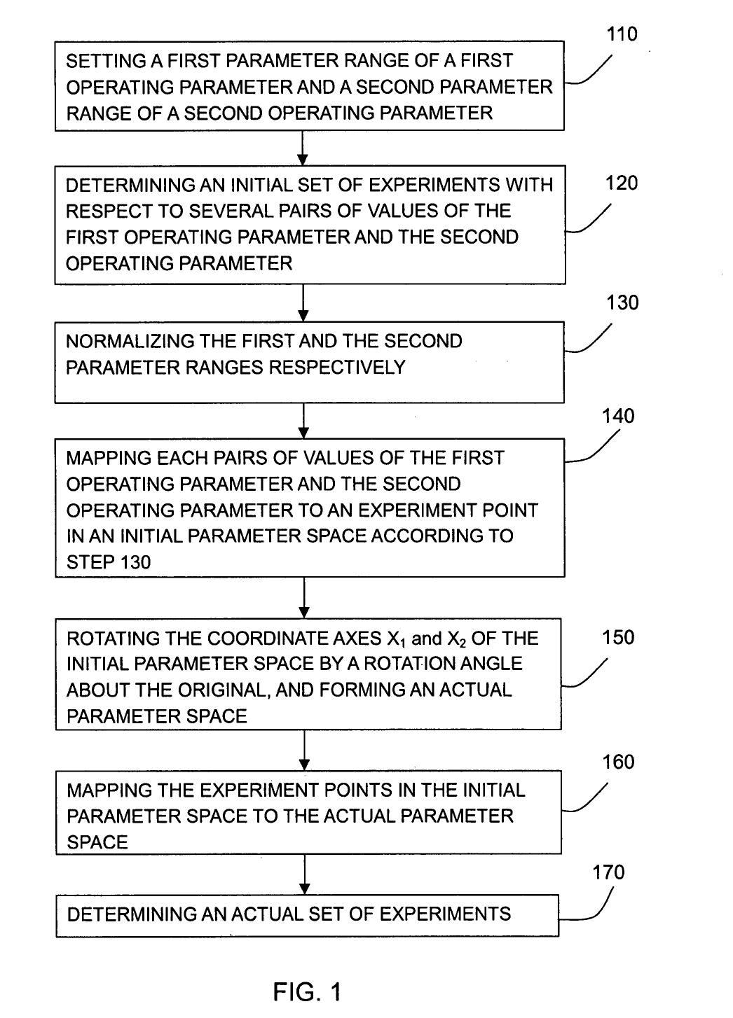

Please refer to FIG. 1. FIG. 1 is flowchart illustrating a method for determining a parameter space for finding optimal operating parameters for recording or writing a storage medium, according to an embodiment of the invention.

In a first step 110 of FIG. 1, a first parameter range of a first operating parameter and a second parameter range of a second operating parameter are respectively set first. And then, in step 120, an initial set of experiments is determined with several pairs of values of the first operating parameter and the second operating parameter within their own parameter ranges.

In step 130, the first and the second parameter ranges are respectively normalized. For example, the first and the second parameter ranges are respectively normalized as a parameter space range between “α” and “−α” by linear interpolation, wherein the first operating parameter is denoted by X₁ and the second parameter is denoted by X₂. In step 140, each pairs of values of the first operating parameter and the second operating parameter with respect to each experiment is mapped to an experiment point in an initial parameter space according to the result of step 130. That is, the initial parameter space is formed based on the normalized first and second parameter ranges.

For example, 13 experiments based on code q=0.5 and α=1 are taken, meaning a normalization of the operating parameters (α=1 means that the total range is used; q=0.5 means that half of the range is used), as illustrated in FIG. 2. Referring to FIG. 2, 13 experiment points representing 13 experiments are associated with 13 pairs of values of two operating parameters: the first operating parameter denoted by X₁ and the second operating parameter denoted by X₂. In other examples, 9+4n experiments, where n is a nonzero integer, for instance 9 experiments, can be taken as well, wherein for a specific value of n, a set of (9+4n) experiments has a distribution pattern in the initial parameter space 20 as a grid of experiment points including a central point. In addition, the initial set of experiments is used in a design of experiments method, for example.

For the sake of illustration, the above-mentioned experiments in TABLE 1 are taken and can be represented as normalized parameters in FIG. 2, wherein the first operating parameter X₁ represents the normalized power P and the second operating parameter X₂ represents the normalized pulse width T_{MP}_{_{—}}_{P}. In TABLE 1, the values of the two operating parameters P and T_{MP}_{_{—}}_{P} are in a first parameter range from 230 to 320 and a second parameter range from 9.25 to 11.5, respectively. As an example, the first parameter range is normalized as a range of −1 to 1 and the second parameter range as a range of −1 to 1, wherein “α” is illustrated to be 1. The normalization of operating parameters in TABLE 1 results in a number of points representing the initial set of experiments in an initial parameter space with respect to the first parameter X₁ and the second parameter X₂ in FIG. 2. As can be observed, the initial set of experiments in FIG. 2 has a distribution pattern as a grid of experiment points in this example. In addition, any experiment point in the initial parameter space in FIG. 2 can be mapped to “real” parameters, according to the first and second ranges, for example, by linear interpolation.

In order to avoid the failed experiment points happened in the “corner”, such as the points 201 to 204 in the FIG. 2. In step 150, the coordinate axes X₁ and X₂ of the initial parameter space are rotated by a rotation angle about the original to form an actual parameter space, and new coordinate axes X₂₁ and X₂₂ are set. The actual parameter space is formed based on the rotated initial parameter space.

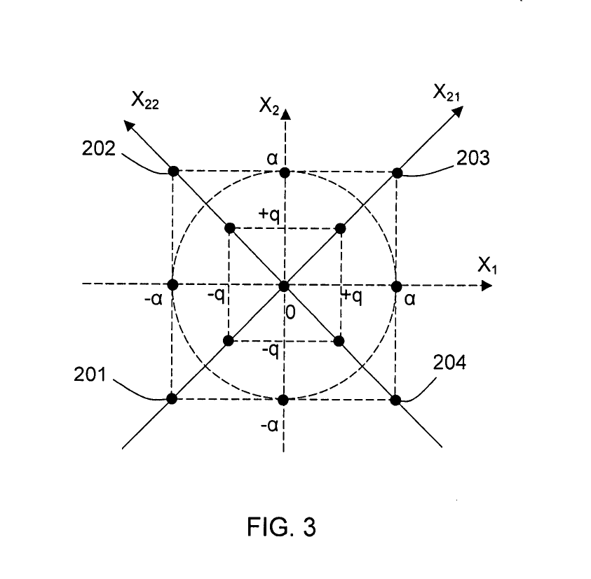

Please refer to FIG. 3. FIG. 3 illustrates a rotation of an initial parameter space about the central point by a rotation angle for determining an actual parameter space in setting an actual set of experiments, according to an embodiment of the invention. As illustrated in FIG. 3, the actual parameter space results from a rotation of the initial parameter space with axes X₁ and X₂ about the origin, i.e. the central point of the distribution pattern, by a rotation angle of 45° counterclockwise, for example.

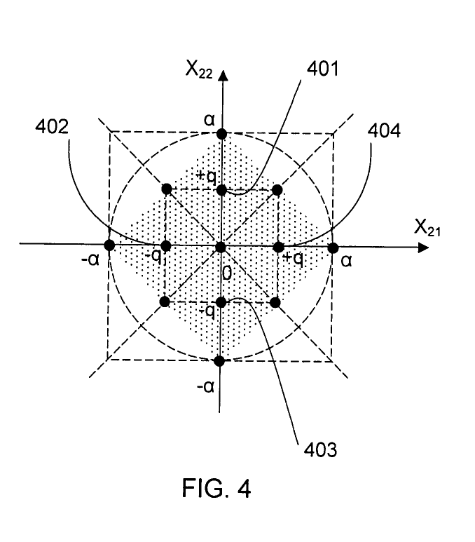

Step 160 is then performed to map the experiment points in the initial parameter space to the actual parameter space as shown in FIG. 4. According to the result of step 160, an actual set of experiments is determined in step 170. As the actual set of experiments is determined in step 170, each of experiments is performed to measure the characteristic measurement values, therefore, to find the optimal operating parameters. According to the new-defined actual parameter space as shown in FIG. 4, the experiment points located at the corner of the initial parameter space are avoided, and the actual set of experiments determined from the actual parameter space is more reliable.

According to step 150 and step 160, all values of a first operating parameter and a second operating parameter for the actual set of experiments in FIG. 4 are provided based on the distribution pattern of the initial set of experiments in an actual parameter space, as indicated in FIG. 3, with the perpendicular axes X₂₁ and X₂₂ in the actual parameter space. The actual parameter space results from a rotation of the initial parameter space with axes X₁ and X₂ about the origin, i.e. the central point of the distribution pattern, by a rotation angle of 45° counterclockwise, for example, as illustrated in FIG. 3.

In order to maintain the same ranges for the values of operating parameters in the actual set of experiments as those in the initial set of experiments, the values of experiment points in view of the actual parameter space in FIG. 3 are contracted. For example, the values of experiment points in FIG. 3 are proportionally scaled down with respect to the operating parameters X₂₁ and X₂₂ of the actual parameter space to make the respective ranges of the values of experiment points being in the normalized range of [−1, 1]. In this way, the distribution pattern of the initial set of experiments as shown in FIG. 2 is mapped to a distribution pattern as shown in FIG. 4. The actual set of experiments is determined according to the distribution pattern in FIG. 4. The values of actual parameters of the actual set of experiments can be derived from the distribution pattern in FIG. 4, using the first and second parameter ranges of the actual parameters in TABLE I. Moreover, in the above example, the number of the actual set of experiments has the same number of the initial set of experiments.

A wide as possible parameter range is preferred to enable the method of determining operating parameters to find the optimal operating parameter setting. In addition, a sufficient large range is needed to obtain enough dynamic range in the resulting characteristic measurement values. Thus, the actual set of experiments is determined as indicated in FIG. 4, according to step 170. As compared to the initial set of experiments represented in FIG. 2, the distribution pattern of the actual set of experiments avoids the four corners, such as corners 201 to 204 in FIG. 2, as well as the corner regions about the four corner points. In addition, four points, not included in FIG. 2, are present in FIG. 4, such as a point 401 on an axis X₂₂, points 402, 403, and 404. Further, the values of all these experiment points in FIG. 4 are kept in the normalized ranges, i.e. [−1, 1], for both two operating parameters.

In the above example, the values of experiment points for the actual set of experiments can be calculated by the coordinates transformation expression in matrix form below:

$$( \begin{matrix}{x}^{′} \\ {y}^{′}\end{matrix} ) = A ( \begin{matrix}cos θ & sin θ \\ - sin θ & cos θ\end{matrix} ) ( \begin{matrix}x \\ y\end{matrix} ) , \qquad ( 1 )$$

where (x, y) are the original coordinates of a point and (x′, y′) are the coordinates of the point after rotation of the axes about the origin by a rotation angle of θ counterclockwise, and A is the scalar factor for normalization. For the above example of the actual set of experiments, the rotation angle θ is 45° and A=1/\sqrt{2}. The following TABLE 2 lists, in terms of normalized values, the initial set of experiments taken the example in TABLE 1 and the actual set of experiments according to the initial set of experiments, based on an actual parameter space rotated about the origin by a rotation angle of 45°.

TABLE 2

| SET | |
|---|---|
| 1 | 2 |

| EXP. | X₁ | X₂ | X₂₁ | X₂₂ |
|---|---|---|---|---|
| 0 | 0 | −1 | −0.5 | −0.5 |
| 1 | 0 | 0 | 0 | 0 |
| 2 | −0.5 | +0.5 | 0 | 0.5 |
| 3 | 1 | 0 | 0.5 | −0.5 |
| 4 | +0.5 | −0.5 | 0 | −0.5 |
| 5 | −1 | 0 | −0.5 | 0.5 |
| 6 | 0 | +1 | 0.5 | 0.5 |
| 7 | −0.5 | −0.5 | −0.5 | 0 |
| 8 | +0.5 | +0.5 | 0.5 | 0 |
| 9 | −1 | −1 | −1 | 0 |
| 10 | −1 | +1 | 0 | 1 |
| 11 | +1 | +1 | 1 | 0 |
| 12 | +1 | −1 | 0 | −1 |

Since the corner point has been avoided in the actual set of experiments, the actual set of experiments is performed on the storage medium using the experimental plan. For example, the operating parameters (or experiments) are changed on the fly at every storage medium revolution transition and test data are written on the storage medium. At each experiment, characteristic measurement values are measured, and the optimal operating parameters are determined by the result of the characteristic measurement values. The normalized (or coded) optimal operating parameter values can be mapped to real operating parameter values by linear interpolation according to the first and second ranges of TABLE 1.

According to the embodiments of the invention, a method for determining a parameter space for finding optimal operating parameters for reading or writing storage medium is provided. An actual parameter space is generated according to an initial parameter space, based on a rotation of the initial parameter space with respect to the two operating parameters in order to avoid the invalid characteristic measurement values happened in the corner points of the initial parameter space. An actual set of experiments generated based on the actual parameter space are expected to result in more reliable operating parameters than the initial set of experiments in finding optimal operating parameters.

In addition, in one example above, a wide as possible operating parameter range is preferred and kept in the actual set of experiments to enable the method of determining operating parameters to find the optimal operating parameter setting. In addition, if the initial set of experiments having a sufficient large range, the actual set of experiments can also keep such range that is needed to obtain enough dynamic range in the resulting characteristic measurement values.

Moreover, although one example above taking a rotation angle of θ being 45° about the central point of the distribution pattern of experiments, the number of the actual set of experiments being the same as that of the initial set, and the scalar factor A=1/\sqrt{2}, these values can be changed in different situations. For example, in other example, a rotation angle of 30° is taken. In one example, the number of the actual set of experiments may be more than the number of the initial set of experiments to increase the resolution and accuracy of the optimal results. Further, the first and the second parameter ranges can be normalized, in other examples, as respective parameter space ranges with different end values, instead of a parameter space range between “α” and “−α” by linear interpolation. All possible changes to these values can be made as long as one or more failed experiment of the initial set of experiments that have been found substantially at one or more corner points of the parameter space can be avoided in the actual set of experiments so that the optimal operating parameters thereby obtained are reliable.

Furthermore, write strategy parameters other than the two parameters, power P and pulse width T_{MP}_{_{—}}_{P}, taken in the above example, or combinations of them, can also be taken in determining optimal write strategy parameters. In a further embodiment of present invention, the first and second operating parameters are servo parameters. Similar to the write strategy parameters, servo parameters can be optimized by a set of experiments especially when these servo parameters are showing a correlation. Examples of such servo parameters are the focus-distance of the objective lens with respect to the storage medium and the spherical aberration correction device setting.

While the invention has been described by way of examples and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for determining a parameter space for finding optimal operating parameters for reading or writing a storage medium, the method comprising:
(a) setting a first parameter range of a first operating parameter and a second parameter range of a second operating parameter;
(b) normalizing the first and the second parameter ranges respectively and forming an initial parameter space based on the normalized first and second parameter ranges; and
(c) rotating the initial parameter space by a rotation angle and forming an actual parameter space based on the rotated initial parameter space.

2. The method according to claim 1 further comprising determining an actual set of experiments based on the actual parameter space.

3. The method according to claim 1, wherein the rotation angle is 45 degree.

4. The method according to claim 1, wherein the first and the second parameter ranges are normalized as a parameter space range between “α” and “−α” by linear interpolation.

5. The method according to claim 1, wherein an initial set of experiments is set with respect to several pairs of values of the first and the second operating parameters.

6. The method according to claim 5, wherein each of the initial set of experiments is mapped to an experiment point in the initial parameter space.

7. The method according to claim 6, wherein an actual set of experiments is determined by mapping the experiment points to the actual parameter space.

8. The method according to claim 5, wherein the initial set of experiments has 9+4n experiments, where n is a non-zero integer and the initial set of experiments are used in a design of experiments method.

9. A method for determining a set of experiments for finding optimal operating parameters for reading or writing a storage medium, the method comprising:
(a) setting a first parameter range of a first operating parameter and a second parameter range of a second operating parameter;
(b) determining an initial set of experiments with respect to several pairs of values of the first operating parameter and the second operating parameter;
(c) normalizing the first and the second parameter ranges respectively and forming an initial parameter space based on the normalized first and second parameter ranges;
(d) mapping each of the initial set of experiments to an experiment point in the initial parameter space;
(e) rotating the initial parameter space by a rotation angle and forming an actual parameter space based on the rotated initial parameter space;
(f) mapping the experiment points in the initial parameter space to the actual parameter space; and
(g) determining an actual set of experiments according to the step (f).

10. The method according to claim 9, wherein the rotation angle is 45 degree.

11. The method according to claim 9, wherein the first and the second parameter ranges are normalized as a parameter space range between “α” and “−α” by linear interpolation.

12. The method according to claim 9, wherein the values of the first and second operating parameters of the actual set of experiments in the actual parameter space are proportionally scaled down so as to keep the values of the first operating parameter and the values of the second operating parameter for the actual set of experiments in the first parameter range and the second parameter range respectively.

13. The method according to claim 9, wherein the initial set of experiments has 9+4n experiments, where n is a non-zero integer and the initial set of experiments are used in a design of experiments method.

14. The method according to claim 9, wherein the initial set of experiments and the actual set experiments have the same number of experiments, and the initial and the actual sets of experiments are used in a design of experiments method.

15. The method according to claim 9, wherein the first and second operating parameters are write strategy parameters, such that after determining the actual set of experiments, each of the actual set of experiments is performed by recording data on the storage medium and a received signal from the storage medium is obtained by reading the recorded data on the storage medium.

16. The method according to claim 9, wherein the first and second operating parameter are servo parameters, such that after determining the actual set of experiments, each of the actual set of experiments is performed by setting the servo parameters and a received signal from the storage medium is obtained by reading the data on the storage medium.
